(19) United States
(12) Patent Application Publication
(10) Pub. No.: US 2006/0072175 A1
(43) Pub. Date: Apr. 6, 2006

(54) 3D image printing system

(76) Inventor: Takahiro Oshino, Tochigi-ken (JP)

Correspondence Address: COWAN LIEBOWITZ & LATMAN P.C.;JOHN J TORRENTE, 1133 AVE OF THE AMERICAS, NEW YORK, NY, 10036, US

(21) Appl. No.: 11/244,690

(22) Filed: Oct. 6, 2005

(30) Foreign Application Priority Data
Oct. 6, 2004 (JP) 2004-294203

(51) Int. Cl. H04N 1/46

(52) U.S. Cl. 358/537

(57) ABSTRACT

An object of this invention is to provide a 3D image printing system capable of generating a 3D print image suitable for a printing apparatus from edited 3D image information and printing the generated 3D print image. A 3D image printing system according to this invention includes a managing apparatus which saves the first 3D image information used to generate a 3D image, an editing apparatus which edits the 3D image, and a printing apparatus which prints the 3D image, wherein the editing apparatus edits the first 3D image information received from the managing apparatus in accordance with 3D editing operation, and the managing apparatus receives the second 3D image information edited by the editing apparatus, generates a 3D print image on the basis of the second 3D image information and 3D print information on 3D printing of the printing apparatus, and causes the printing apparatus to print the 3D print image.

### FIELD OF THE INVENTION

The present invention relates to a printing system for a three-dimensional (3D) image and, more particularly, to a system which edits 3D image information and 3D-prints the editing result.

### BACKGROUND OF THE INVENTION

Various schemes have been developed as a method of 3D-displaying a 3D image. Of these schemes, a 3D display apparatus which utilizes binocular parallax with which images having a parallax between two, right and left eyes are presented so that the observer sees a 3D vision has widely been utilized. Especially, many types of a binocular stereoscopic display scheme which presents images acquired and generated at two different viewpoints are available. Further, a multi-view stereoscopic display scheme which has a view area including many viewpoints and realizes a smooth motion parallax has also been examined.

For example, an image processing apparatus disclosed in US-2001-0052935-A1 extracts a parallax map representing the depth distribution of a stereoscopic image photographed by a camera having a 3D picture adaptor. Based on the parallax map and stereoscopic image, the image processing apparatus creates the multi-viewpoint image sequence of an object from a plurality of viewpoints which have not been used for photographing. The image processing apparatus creates a multi-view composite image with a pixel arrangement corresponding to a predetermined optical member from the created multi-viewpoint image sequence, and prints the multi-view composite image by a printing apparatus. The image processing apparatus allows the observer to observe a smooth motion parallax by observing the printed multi-view composite image using the predetermined optical member.

FIG. 16 schematically shows a state in which a two-dimensional (2D) image is acquired using four cameras for the multi-view stereoscopic display scheme. In FIG. 16, four cameras 1601 to 1604 are laid out on a base line 1605 at predetermined intervals so that their optical centers (optical axis of the imaging optical system) become parallel to each other. A multi-view composite image which has a pixel arrangement and can implement a 3D vision by using a lenticular lens 1702 as shown in FIG. 17 is generated from 2D images (viewpoint images) acquired by the respective cameras.

Letting Pⱼₘₙ (m and n are the indices of horizontal and vertical pixel arrangements) be a pixel value at the jth viewpoint, the jth image data is given as the following 2D matrix:

$${P}_{j11} {P}_{j21} {P}_{j31} … \\ {P}_{j12} {P}_{j22} {P}_{j32} … \\ {P}_{j13} {P}_{j23} {P}_{j33} … \qquad [ Matrix 1 ]$$

Since the observation optical system is assumed to be a lenticular lens, the pixel arrangement of a composite image is obtained by vertically decompositing viewpoint images into the stripes of respective lines, and horizontally arranging the stripe-shaped pixel lines by the number of viewpoints in an order opposite to the arrangement order of viewpoints. A multi-view composite image is, therefore, converted into a stripe image having the following pixel arrangement:

$${P}_{411} {P}_{311} {P}_{211} {P}_{111} {P}_{421} {P}_{321} {P}_{221} {P}_{121} {P}_{431} {P}_{331} {P}_{231} {P}_{131} … \\ {P}_{412} {P}_{312} {P}_{212} {P}_{112} {P}_{422} {P}_{322} {P}_{222} {P}_{122} {P}_{432} {P}_{332} {P}_{232} {P}_{132} … \\ {P}_{413} {P}_{313} {P}_{213} {P}_{113} {P}_{423} {P}_{323} {P}_{223} {P}_{123} {P}_{433} {P}_{333} {P}_{233} {P}_{133} … \qquad [ Matrix 2 ]$$

In this case, the pixel (circled number 1 in FIG. 16) of a viewpoint image corresponding to viewpoint 1 is arranged at the left end, and the pixel (circled number 4 in FIG. 16) of a viewpoint image corresponding to viewpoint 4 is arranged at the right end. This arrangement is circularly repeated.

The arrangement order of viewpoint images is reversed from that of viewpoints because in observation through the lenticular lens, an image is observed reversely in the horizontal direction at one pitch of the lens part of the lenticular lens.

When the number of original viewpoint images is N at a size of H×v, the size of a multi-view composite image is X (=N×H)×v.

The pitches of lens parts of the lenticular lens are adjusted for the multi-view composite image. N pixels at RP dpi exist at one pitch, and thus one pitch=N/RP inches. When the pitch of the lenticular lens is RL inches, the pitches are adjusted by multiplying the image by RL×RP/N in the horizontal direction.

At this time, the number of pixels in the vertical direction must be (RL×RP/N)×Y, and the magnification is adjusted by multiplying the image by (RL×RP×Y)/(N×v) in the vertical direction.

The above-described horizontal and vertical scaling processes are done for a multi-view composite image, generating and printing the resultant image. The lenticular lens 1702 is superposed on a print result 1701 as shown in FIG. 17, and the observer can observe the print result 1701 as a 3D image.

For descriptive convenience, four cameras are used to photograph a viewpoint image. A similar multi-view composite image is also generated when the number of cameras is larger, or when one camera is moved to photograph an object. Further, a stereoscopic image may be input from a camera equipped with a stereoscopic adaptor that is disclosed in US 2001/052935. In this case, corresponding points are extracted from the stereoscopic image, a parallax map representing the depth is created from the extraction results, and the parallax map is mapped forward, thereby creating a 2D image corresponding to a position (new viewpoint) at which no image is photographed.

FIG. 18 shows an example of a 3D display apparatus using a conventional lenticular lens.

In the 3D display apparatus shown in FIG. 18, an LCD display unit 1802 is arranged behind a lenticular lens 1801. The LCD display unit 1802 is formed by interposing an LCD display pixel unit 18022 between glass substrates 18021 and 18023. The display pixel unit 18022 is arranged in the focus plane of the lenticular lens 1801.

Two-dimensional stripe images which are acquired and generated at predetermined photographing positions as shown in FIG. 17 are rendered on the display pixel unit 18022, and images having a parallax are presented to two eyes 1803 and 1804 of the observer, presenting a 3D vision. The present applicant has also proposed a 3D display apparatus in which a multi-view composite image is formed in a matrix, an aperture mask corresponding to the matrix arrangement is arranged in front of the multi-view composite image, light coming from each horizontal pixel line enters only a corresponding horizontal line of the mask by using a transverse lenticular lens or the like, and thereby a decrease in the resolution of the multi-view composite image is made inconspicuous.

The above-mentioned 3D display apparatus and 3D image printing apparatus adopt the same stereoscopic technique. A 3D image for 3D vision is generally formed uniquely to each apparatus owing to differences in optical member used for 3D vision, pixel resolution, display size, and the like.

Even if a 3D image is edited while being stereoscopically observed on a given 3D display apparatus, it is difficult to print a 3D image having the same 3D effect by a 3D image printing apparatus.

### SUMMARY OF THE INVENTION

According to one aspect of the present invention, a 3D image printing system (or a 3D image printing method using the system) uses a managing apparatus which saves first 3D image information used to generate a 3D image, an editing apparatus which edits the 3D image, and a printing apparatus which prints the 3D image. The editing apparatus edits the first 3D image information received from the managing apparatus in accordance with 3D editing operation. The managing apparatus receives second 3D image information edited by the editing apparatus, generates a 3D print image on the basis of the second 3D image information and 3D print information on 3D printing of the printing apparatus, and causes the printing apparatus to print the 3D print image.

According to another aspect of the present invention, a 3D image printing system (or a 3D image printing method using the system) uses a managing apparatus, an editing apparatus which edits a 3D image, and a printing apparatus which prints the 3D image. The editing apparatus generates 3D image information used to generate the 3D image, in accordance with 3D editing operation using a photographed image acquired from a photographing apparatus. The managing apparatus receives the 3D image information from the editing apparatus, generates a 3D print image on the basis of the 3D image information and 3D print information on 3D printing of the printing apparatus, and causes the printing apparatus to print the 3D print image.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principle of the invention.

FIG. 1 is a block diagram showing the configuration of a 3D image printing system according to the first embodiment of the present invention;

FIG. 2 is a block diagram showing the physical configuration of the 3D image printing system according to the first embodiment;

FIG. 3 is a flowchart showing the overall process of the 3D image printing system according to the first embodiment;

FIG. 4 is a sequence chart of the 3D image printing system according to the first embodiment;

FIG. 5 is a view showing an example of a list of 3D scenes and 3D models according to the first embodiment;

FIG. 6 is a flowchart showing the process of a 3D display control terminal according to the first embodiment;

FIG. 7 is a view for explaining an example of a 3D scene according to the first embodiment;

FIG. 8 is a view for explaining a data structure for managing a 3D scene and 3D model;

FIG. 9 is a view for explaining a window for editing a 3D scene according to the first embodiment;

FIG. 10 is a flowchart showing the process of a 3D image managing server according to the first embodiment;

FIG. 11 is a flowchart showing the overall process of a 3D image printing system according to a modification to the first embodiment;

FIG. 12 is a block diagram showing the configuration of a 3D image printing system according to the third embodiment of the present invention;

FIG. 13 is a flowchart showing the overall process of the 3D image printing system according to the third embodiment;

FIGS. 14A and 14B are views for explaining 3D display and editing of acquired image data according to the third embodiment;

FIG. 15 is a sequence chart of the 3D image printing system according to the third embodiment;

FIG. 16 is a view for explaining a camera layout in conventional four-view 3D image photographing;

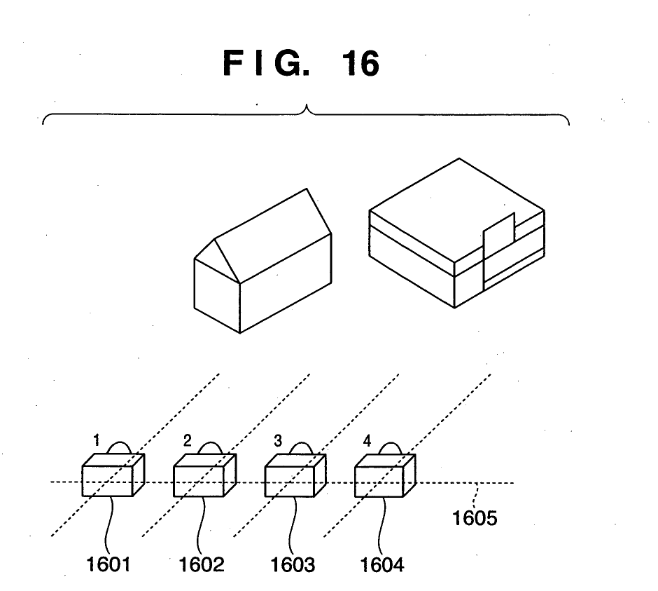

FIG. 17 is a view for explaining conventional four-view 3D image printing; and

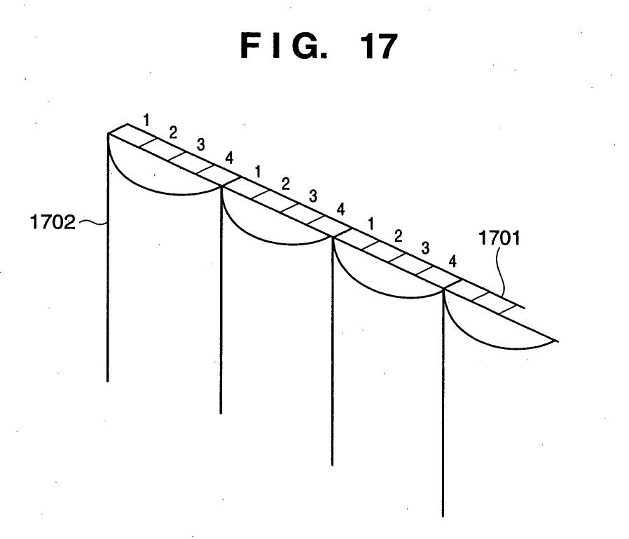

FIG. 18 is a view for explaining the structure of a conventional 3D display device using a liquid crystal element.

### DETAILED DESCRIPTION OF THE PREFERRED EMBODIMENTS

An object of embodiments is to provide a 3D image printing system capable of generating a 3D print image suitable for a printing apparatus from edited 3D image information and printing the generated 3D print image.

Preferred embodiments of the present invention will be described below with reference to the accompanying drawings.

### First Embodiment

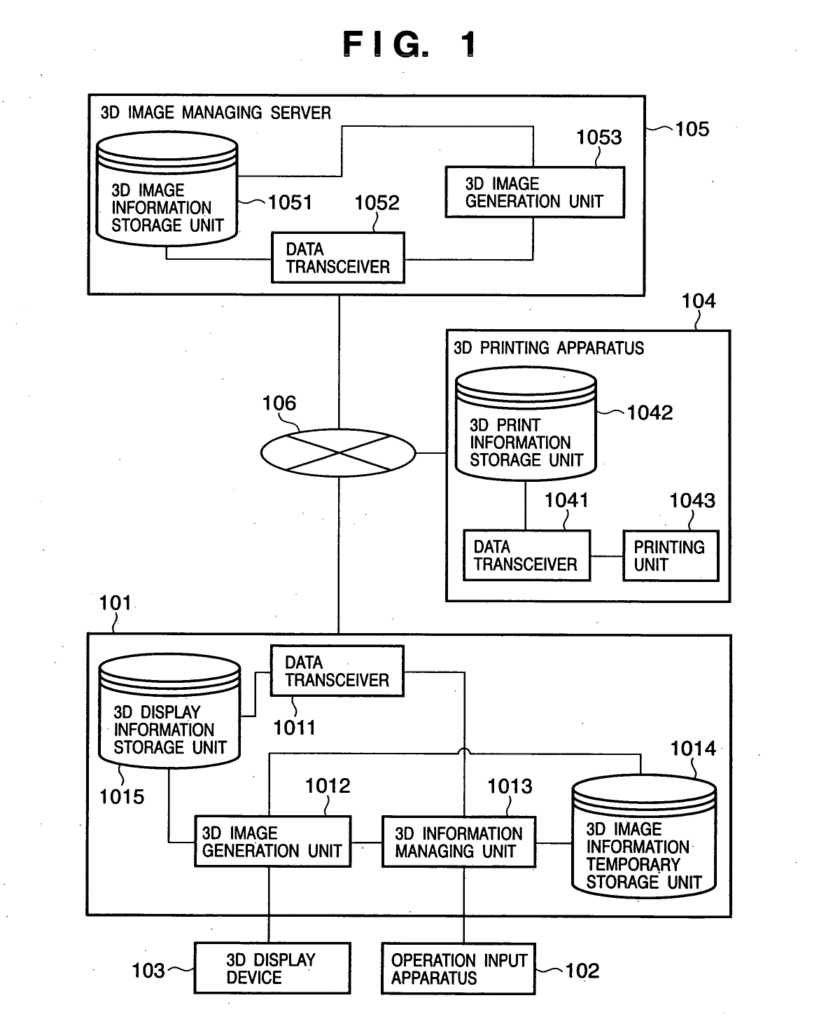

FIG. 1 shows the configuration of a 3D image printing system according to the first embodiment of the present invention. In the 3D image printing system according to the first embodiment, a 3D display control terminal 101 which displays a 3D image on a 3D display device 103, a 3D image managing server 105 which manages 3D image information, and a 3D image printing apparatus 104 are connected to each other via a network 106.

The 3D image managing server 105 comprises a 3D image information storage unit 1051, data transceiver 1052, and 3D image generation unit 1053, and is formed from, e.g., a general-purpose computer.

The 3D image information storage unit 1051 stores 3D image information which is created by general 3D model creation software or the like and used to generate a 3D image such as a 3D scene or 3D model. The 3D model is formed from vertexes, the reflection property of the surface, texture, and the like. In order to make the display resolution match the 3D display control terminal 101 and the communication speed of a communication network, the 3D image information storage unit 1051 may store a plurality of 3D models or 3D scenes which are identical but different in the number of vertexes, the fineness of texture, or the like.

The 3D image generation unit 1053 generates a 3D print image suitable for the 3D image printing apparatus 104 (to be described later). The data transceiver 1052 exchanges various data with the 3D display control terminal 101 and 3D image printing apparatus 104 via the network 106.

The 3D display control terminal 101 is connected to the 3D display device 103 which present a 3D vision via a specific optical system, and an operation input apparatus 102 used when the user interactively operates the 3D display control terminal 101. The 3D display control terminal 101 is formed from, e.g., a general-purpose computer, and functions as a 3D image editing apparatus capable of selecting a 3D scene or 3D model acquired from the 3D image managing server 105 via the operation input apparatus 102, or interactively changing the 3D effect, the position, orientation, and viewpoint of a 3D model, and thereby performing editing such as 3D adjustment and processing while presenting a 3D vision on the 3D display device 103.

The 3D display control terminal 101 comprises a data transceiver 1011, 3D image information temporary storage unit 1014, 3D display information storage unit 1015, 3D display image generation unit 1012, and 3D information managing unit 1013.

The data transceiver 1011 exchanges image data and the like with the 3D image managing server 105 via the network 106. The 3D image information temporary storage unit 1014 stores 3D image information such as a 3D scene or 3D model. The 3D display information storage unit 1015 stores 3D display information as display-specific parameters associated with 3D display of the 3D display device 103. The 3D display image generation unit 1012 generates a 3D display image to be displayed on the 3D display device 103. The 3D information managing unit 1013 manages all pieces of 3D image information such as a 3D scene and 3D model, and all pieces of information (3D edit information) on 3D editing operation such as adjustment and processing for a 3D scene input by the user.

The operation input apparatus 102 is a pointing device used to designate an operation command by the user to the 3D display control terminal 101, move a displayed 3D model, or move the viewpoint position. The operation input apparatus 102 is formed from a button, mouse, joy stick, keyboard, and the like.

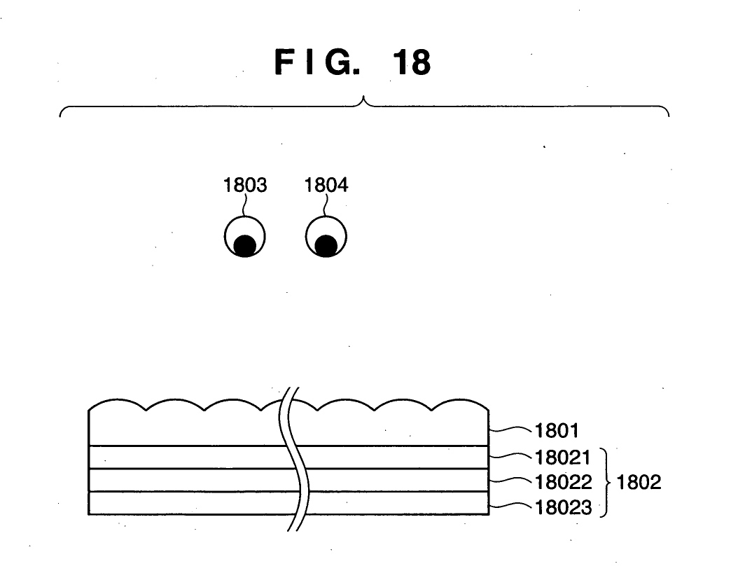

The 3D display device 103 displays a 3D image created by the 3D display control terminal 101 via a specific optical member so that the user can see a 3D vision. The 3D display device 103 is formed from, e.g., a stereoscopic display using a lenticular lens having the structure shown in FIG. 18.

The 3D image printing apparatus 104 comprises a data transceiver 1041, 3D print information storage unit 1042, and printing unit 1043. The data transceiver 1041 exchanges various data with the 3D image managing server 105 via a communication network. The 3D print information storage unit 1042 stores apparatus-specific information as parameters associated with 3D printing of the 3D image printing apparatus 104. The printing unit 1043 prints, on a predetermined medium, a 3D print image transferred from the 3D image managing server 105, and the user can observe the 3D image by stereoscopically seeing the print result via a predetermined optical member.

The network 106 is a communication network which connects the 3D display control terminal 101, 3D image managing server 105, and 3D image printing apparatus 104, and may be an open network (e.g., the Internet), a closed network (e.g., a LAN), an intranet as a combination of them, or a wired or wireless network. Data exchange on this network preferably employs a well-known data transfer technique.

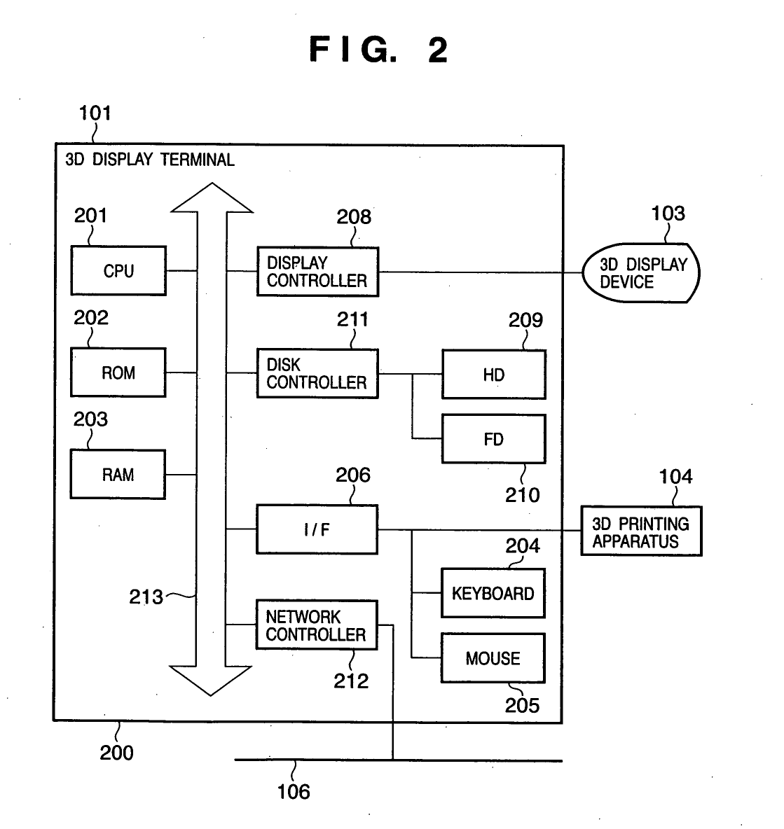

FIG. 2 shows the physical configurations of the 3D display control terminal 101 and 3D image managing server 105 according to the first embodiment. The 3D display control terminal 101 is formed from a general-purpose computer, as described above, and constructed by communicably connecting an interface (I/F) 206, display controller 208, disk controller 211, and network controller 212 via a system bus 213. A CPU 201, ROM 202, RAM 203, keyboard 204, and mouse 205 are connected to the I/F 206. The 3D display device 103 is connected to the display controller 208. A hard disk (HD) 209 and floppy® display (FD) 210 are connected to the disk controller 211. The system bus 213 is connected to a network 214 (106 in FIG. 1) via the network controller 212.

The CPU 201 comprehensively controls building components connected to the system bus 213 by executing software stored in the ROM 202 or HD 209, or software supplied from the FD 210. That is, the CPU 201 performs control for implementing functions according to the first embodiment by reading out a predetermined processing program from the ROM 202, HD 209, or FD 210 and executing the program.

The RAM 203 functions as a main storage, work area, or the like for the CPU 201. The I/F 206 controls an instruction input from a pointing device such as the keyboard 204 or mouse 205.

The display controller 208 controls display, e.g., GUI display on a 3D display device 103. The disk controller 211 controls access to the HD 209 and FD 210 which store a boot program, various applications, edit files, user files, a network managing program, the above-mentioned processing program according to the first embodiment, and the like. The network controller 212 controls exchange of bi-directional data with a device on the network 214.

By the above operation, the user can stereoscopically observe a 3D image on the 3D display device 103 connected to the 3D display control terminal 101. In the present invention, the 3D display control terminal 101 is not limited to a computer having the above configuration. For example, the 3D display control terminal 101 may also be a portable information processing apparatus (e.g., a portable information terminal or cell phone) which is combined with the 3D display device 103 and operation input apparatus 102, or a processing board or chip dedicated to the processing of the present invention.

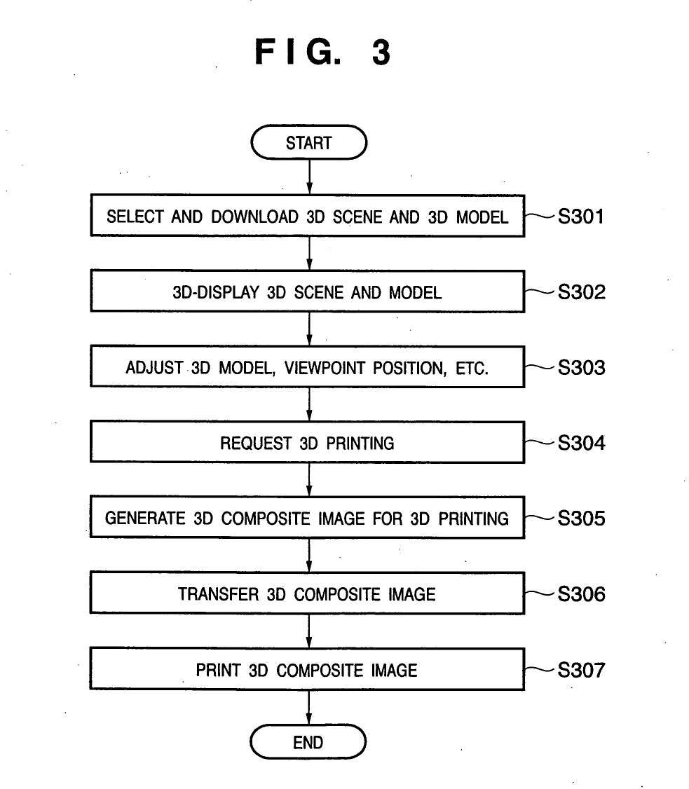

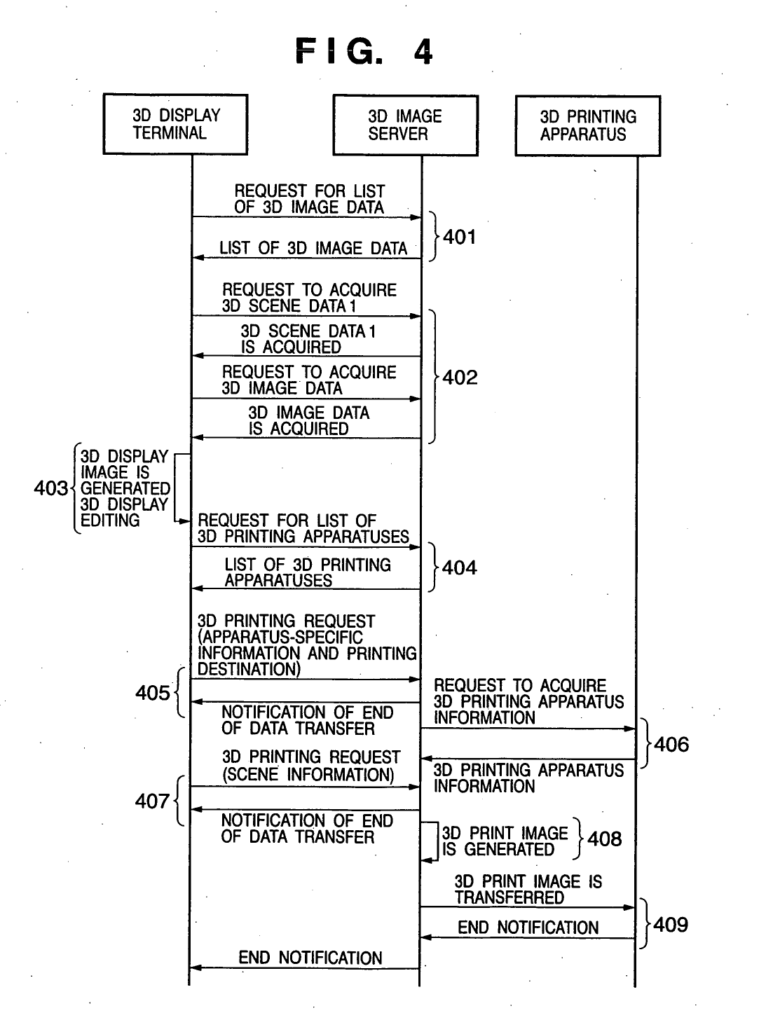

The overall process flow in the 3D image printing system according to the first embodiment will be explained in detail with reference to the flowchart of FIG. 3 and the sequence chart of FIG. 4.

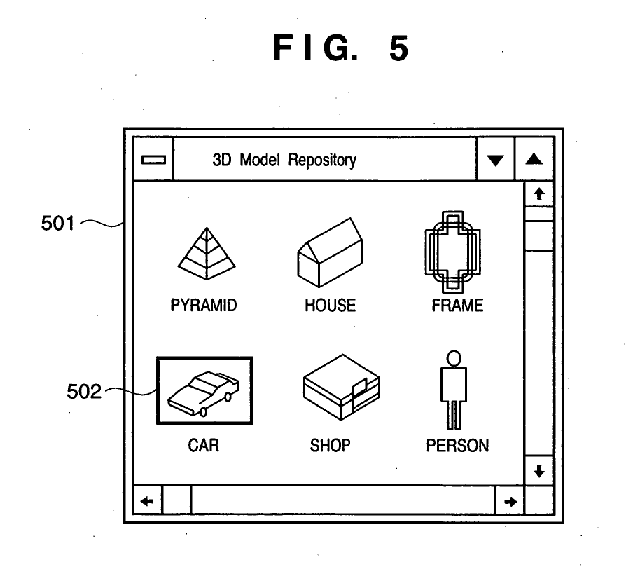

In step S301, in response to an input from the operation input apparatus 102, the 3D display control terminal 101 requests a list of 3D image information such as 3D scenes and 3D models which are registered in the 3D image managing server 105 (401 in FIG. 4). The 3D display control terminal 101 displays the list on the operation input apparatus 102. FIG. 5 shows an example of the list display window. In FIG. 5, a window 501 displays a list of 3D scenes and 3D models 502 which are registered in the 3D image managing server 105.

The 3D display control terminal 101 downloads a selected 3D scene and 3D model from the 3D image managing server 105 in accordance with a selection input from the operation input apparatus 102 (402 in FIG. 4). At this time, the 3D display control terminal 101 may prompt the user to select, e.g., details (the number of vertexes) of a 3D model to be downloaded in accordance with the display performance (e.g., the number of display pixels) of the 3D display device 103. In communication between the 3D image managing server 105 and the 3D display control terminal 101, the 3D image managing server 105 may automatically change details of 3D image information upon reception of information on the 3D display performance of the 3D display control terminal 101. Further, 3D scenes and 3D models may be transferred stepwise in the ascending order of resolution in accordance with information such as the band of a communication network and the communication load.

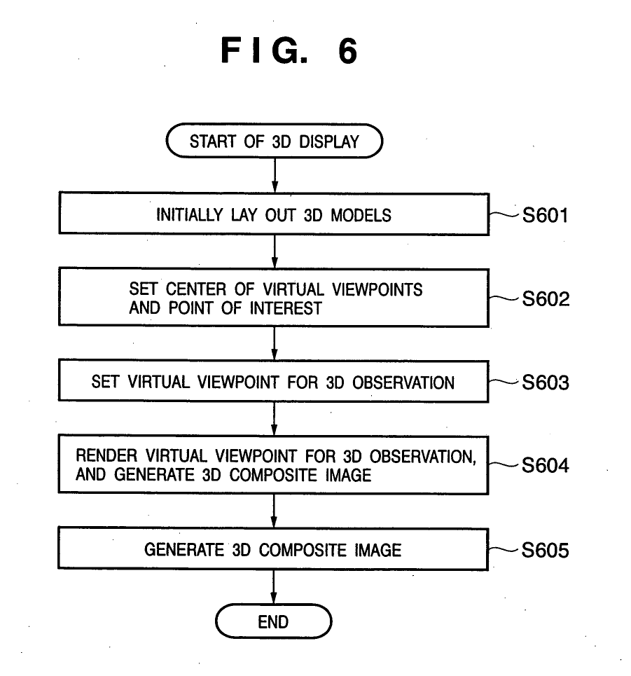

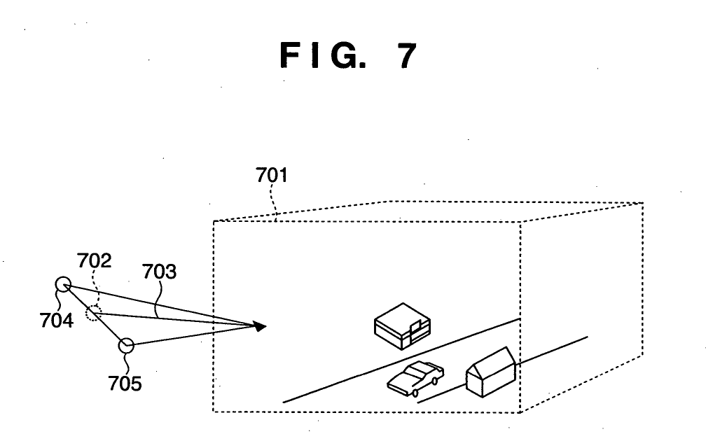

In step S302, the 3D display control terminal 101 3D-displays the 3D scene and 3D model which have been downloaded from the 3D image managing server 105. The process flow of this step will be explained with reference to the flowchart of FIG. 6 and FIG. 7.

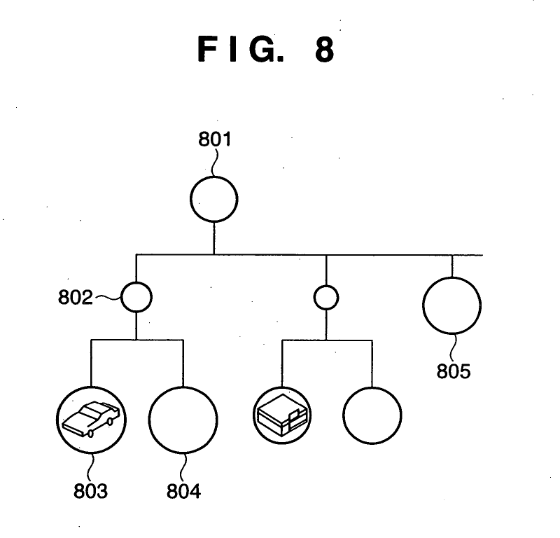

In step S601, a downloaded 3D scene and 3D model are laid out, as shown in FIG. 7. In FIG. 7, a 3D model is initially laid out as a rough center of a 3D scene. As the process result of this step, as shown in FIG. 8, a tree structure which unitarily manages all pieces of information on 3D scenes and 3D models is created. The tree structure in FIG. 8 is a data structure suited to manage all pieces of information such as 3D scenes and 3D models, the attributes of 3D data, and operation (movement, rotation, and enlargement/reduction) to 3D models. The tree structure is a data format which is employed in general computer graphics software.

In FIG. 8, reference numeral 801 denotes a root node of the tree structure below which all objects in a 3D scene are created. Reference numeral 802 denotes a node which means that an object exists below the node 802. For example, the node 802 manages model information 803 of a 3D model, and 3D position information 804 of the model. Reference numeral 805 denotes an attribute such as the size of a 3D scene. Interactive creation by software is facilitated by expressing all objects in a 3D scene by the tree structure.

In step S602, a virtual viewpoint center and the line of sight are determined so that all 3D models are laid out within the 3D scene. The virtual viewpoint center means not a position at which a virtual viewpoint is actually laid out, but a center near which 3D images having a parallax suitable for the 3D display device 103 are acquired. After the virtual viewpoint center is determined, the line of sight is determined. Assuming the central point of the 3D scene to be a point of interest, a direction from the virtual viewpoint center to the point of interest is defined as the line of sight (703 in FIG. 7).

In step S603, virtual viewpoint positions (virtual camera positions) are set near the virtual viewpoint center determined in step S602 so as to attain a parallax suitable for 3D observation on the 3D display device 103. When the 3D display scheme of the 3D display device 103 is, e.g., a two-eyes stereoscopic scheme, virtual viewpoint positions are set at positions 704 and 705 near a virtual line-of-sight center 702, as shown in FIG. 7. The line of sight from each virtual viewpoint is set toward the point of interest designated in step S602.

In step S604, a plurality of virtual cameras set in step S603 are rendered to generate a 3D image. The 3D image is composited suitably for the display form of the 3D display device 103. For example, for a 3D display device using a lenticular lens, an image at each viewpoint is decomposited into stripes, and stripe images are arranged and composited in an order opposite to the arrangement order of viewpoints.

Finally in step S605, the 3D image created in step S604 is transferred to the 3D display device 103. The 3D image displayed on the 3D display device 103 can be stereoscopically observed via a predetermined optical system.

For descriptive convenience, the 3D display device 103 is of a stereoscopic type, but may be a multi-eyes 3D type having a larger number of viewpoints. A display scene which is proposed by the present applicant and arranges a multi-view composite image in a matrix may also be applied. In this case, virtual camera positions corresponding to the display scheme are set. The present invention can be applied to all 3D display schemes of displaying a 3D image which can be formed from 2D images viewed from a plurality of viewpoints.

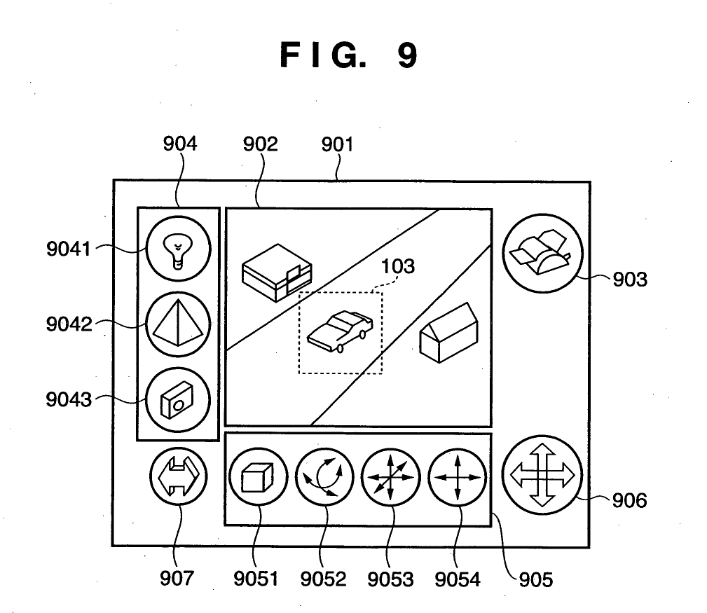

In step S303 of FIG. 3, 3D models, virtual viewpoint positions, and the like are edited in the 3D display control terminal 101 while a 3D vision is presented on the 3D display device 103 (403 in FIG. 4). The concept of editing work is shown in FIG. 9. In FIG. 9, a display area 901 of the 3D display device 103 displays a 3D scene display area 902, operation target selection button 904 (9041 to 9043), operation content instruction button 905 (9051 to 9055), and increment/decrement buttons 906 and 907.

In the 3D scene display area 902, 3D scenes and 3D models which have been selected and downloaded in step S301 are 3D-displayed in a form suited to the 3D display device 103. Of the operation target selection buttons 9041 to 9043, the button 9041 represents a light, the button 9042 represents a 3D model, and the button 9043 represents a virtual viewpoint center. After any one of the buttons 9041 to 9043 is selected, the operation content instruction buttons 9051 to 9054 are designated. Of the operation content instruction buttons 9051 to 9054, the button 9051 is used to select adjustment of the 3D effect of 3D display, the button 9052 is used to rotate a selection target, the button 9053 is used to translate the target, and the button 9054 is used to select enlargement/reduction. Any one of the operation target selection buttons 9041 to 9043 and operation content instruction buttons 9051 to 9054 is operated, and the increment/decrement buttons 906 (X-Y direction) and 907 (direction of depth) are operated. Layout change and processing of a 3D model can be achieved in accordance with user tastes, and the viewpoint position and 3D effect can also be changed.

In the above description, operation such as movement/rotation of a virtual viewpoint means movement/rotation of the virtual viewpoint center 702 in FIG. 7 described above, and the virtual viewpoints (704 and 705 in FIG. 7) for 3D display are accessorily moved and rotated.

The 3D effect can be changed with the 3D effect button 9052 as one of the operation content instruction buttons by changing the interval between the above-described virtual viewpoints 704 and 705 in FIG. 7, i.e., the length of the base line and the point of interest of a 3D scene set in step S602, and converging lines of sight extending from the virtual viewpoints 704 and 705. After the 3D effect is adjusted, the 3D effect can be quickly changed and confirmed on the 3D display device 103.

Three-dimensional image information of the edited 3D scene and 3D model (to be referred to as a 3D scene at once) is finalized in step S304 (to be described later), and transferred from the 3D display control terminal 101 to the 3D image managing server 105.

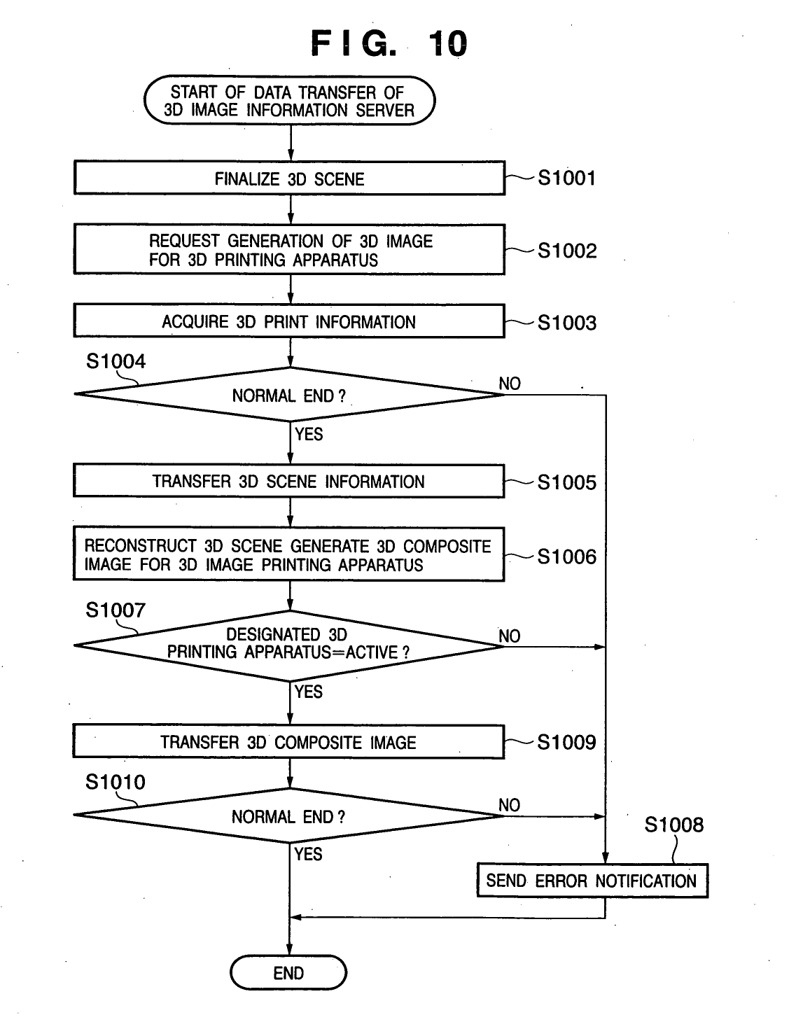

In step S304 of FIG. 3, the 3D image managing server 105 generates a 3D print image suitable for the 3D image printing apparatus 104 on the basis of the 3D image information transferred from the 3D display control terminal 101. A detailed flowchart of this step is shown in FIG. 10. For descriptive convenience, the 3D image printing apparatus 104 is assumed to print a 3D print image of a four-view 3D display type using a lenticular lens as shown in FIG. 18.

In step S1001, edited 3D scene information (edited 3D image information) is finalized while a 3D vision is presented on the 3D display control terminal 101.

In step S1002, which of 3D image printing apparatuses is used for 3D printing is designated at the 3D display control terminal 101 (404 and 405 in FIG. 4). By touching a print button 903 in the display window shown in FIG. 9 in the 3D display control terminal 101 (3D display device 103), a list of 3D image printing apparatuses present on the network 106 is displayed on the 3D display device 103. The user selects a 3D image printing apparatus desired to print from the list via the operation input apparatus 102.

After a 3D image printing apparatus is selected, the 3D display control terminal 101 transfers, to the 3D image managing server 105, a request to perform 3D printing by the selected 3D image printing apparatus 104. At this time, the 3D display control terminal 101 transfers, to the 3D image managing server 105, 3D display information serving as a parameter associated with 3D display of the 3D display device 103. The 3D display information is unique to the 3D display device 103, and contains the device model name (manufacturer and model name), 3D display scheme (e.g., two-eyes stereoscopic scheme), display image form (pixel arrangement style: e.g., stripe image arrangement), screen size, resolution, maximum/minimum parallax amount, and optimal observation distance.

Upon reception of the 3D display information, the 3D image managing server 105 receives an ID and apparatus type (manufacturer name and model name) representing the 3D image printing apparatus 104 desired for 3D printing, and print setting information (e.g., medium size information for 3D printing, and print orientation (portrait/landscape)). The ID suffices to uniquely designate a desired 3D image printing apparatus.

In step S1003, the 3D image managing server 105 acquires apparatus-specific 3D print information serving as a parameter associated with 3D printing of the designated 3D image printing apparatus 104 (406 in FIG. 4). The 3D print information contains the 3D display scheme (e.g., four-view stereoscopic scheme), pixel arrangement style, print resolution, optimal observation distance, maximum/minimum parallax amount, printable medium size (e.g., A4 and postcard), and apparatus type (manufacturer name and model name). This information is uniquely determined by the apparatus type. Note that 3D print information unique to a 3D image printing apparatus of each type is registered in the 3D image managing server 105.

If no 3D print information exists in the 3D image managing server 105, the 3D image managing server 105 may communicate with the designated 3D image printing apparatus 104 to acquire the 3D print information. If the 3D image managing server 105 cannot acquire any 3D print information, it may cause the 3D display control terminal 101 via the network 106 to display a message to this effect, designate the manufacturer of a desired 3D image printing apparatus, and acquire 3D print information from the homepage of the manufacturer or the like. Nevertheless, if the 3D image managing server 105 cannot acquire any 3D print information of the designated 3D image printing apparatus, it causes the 3D display control terminal 101 to display a message to this effect in step S1008, and the process ends.

In step S1005, information on an edited 3D scene to be 3D-printed is transmitted from the 3D display control terminal 101 to the 3D image managing server (407 in FIG. 4). Information on the edited 3D scene contains a data structure which is managed in the 3D display control terminal 101 and expressed as a tree structure, and virtual viewpoint positions and a point of interest which are used to adjust the 3D effect and the like. When the same vertex information of a 3D model in a 3D scene expressed by a tree structure is saved in the 3D display control terminal 101 and 3D image managing server 105, information representing the original 3D model can be transferred to reduce the transfer capacity. When the same vertex information is not saved, particularly when data of a 3D model having a smaller number of vertexes is transferred to the 3D display control terminal 101, the 3D image managing server 105 may automatically change the 3D model to a higher-resolution 3D model. In this case, a high-quality print image can be obtained upon 3D printing by the 3D image printing apparatus 104.

In step S1006, the 3D image managing server 105 reconstructs 3D image information transferred from the 3D display control terminal 101 (408 in FIG. 4). At this time, the number of virtual viewpoints and virtual viewpoint positions are determined on the basis of the acquired 3D print information. The virtual viewpoint position can be determined from 3D print information (e.g., the number of virtual viewpoints corresponding to the 3D display scheme, viewpoint layout, and maximum/minimum parallax amount), and print setting information (e.g., the medium size and orientation for 3D printing).

Determination of the number of virtual viewpoints and virtual viewpoint positions is similar to setting of the virtual viewpoints 704 and 705 shown in FIG. 7 by the 3D display control terminal 101. In this manner, virtual viewpoints are set in correspondence with the 3D image printing apparatus 104, rendering is executed at each viewpoint position, and a 3D print image is generated with a pixel arrangement corresponding to the 3D display scheme of 3D print information. For a 3D image printing apparatus using a four-view type lenticular lens, a 3D print image is obtained by compositing stripe images at viewpoint positions, as represented by 1801 in FIG. 18.

In step S1007, it is confirmed whether the designated 3D image printing apparatus 104 can receive 3D print image data. If the 3D image printing apparatus 104 cannot receive any data, the 3D display control terminal 101 is notified of an error in step S1008. If the 3D image printing apparatus 104 can receive data, the 3D print image is transferred to the 3D image printing apparatus 104 in step S1009 (409 in FIG. 4). At this time, the 3D print image data may be transferred without any change, or if the 3D image printing apparatus 104 has a losslessly compressed-data reception function, 3D print image data which is compressed by a predetermined lossless compression scheme may be transferred.

When the 3D image printing apparatus 104 has only a lossily compressed-data reception function, 3D print image data is preferably transferred without compressing it. This is because image degradation by lossy compression stands out mainly near an edge at which the pixel value greatly changes, a 3D print image degrades at the edge of a stripe, and the 3D effect decreases in 3D vision. However, the present invention is not limited to this when data transfer is limited by the communication band or the like or the compression scheme is a lossy compression scheme dedicated to a 3D image.

In step S1008, it is determined whether the 3D print image has been transferred to the 3D image printing apparatus 104. If no 3D print image has been transferred, the 3D image printing apparatus 104 is notified of a message to this effect in step S909. If printing ends normally, the process ends.

Upon reception of the 3D print image, the 3D image printing apparatus 104 prints the image. A predetermined optical member is superposed on the printed image, and the user can observe a 3D image having almost the same 3D effect as that of a 3D image (3D image observed on the 3D display device 103) which is edited by the 3D display control terminal 101.

As described above, according to the first embodiment, 3D image information (e.g., a 3D scene, 3D model, and virtual viewpoint position) which is downloaded from the 3D image managing server 105 is edited (processed/adjusted) by the 3D display control terminal 101 while being stereoscopically observed on the 3D display control terminal 101 (3D display device 103). The 3D image managing server 105 creates a 3D print image corresponding to the 3D image printing apparatus 104 from the edited 3D image information. The 3D image printing apparatus 104 prints the 3D print image. The user can observe almost the same 3D image as a 3D image which is edited by the 3D display control terminal 101 and observed o the 3D display device 103. Hence, user friendliness of 3D printing can be improved.

The 3D display control terminal 101 downloads and utilizes a simple 3D model suited to the 3D display device 103. Even if the performance for generating a 3D image for display is not high, editing work can be achieved comfortably.

Since a 3D image is generated using a high-resolution 3D model suitable for the 3D image printing apparatus 104, a high-quality 3D image can be printed.

Further, complicated adjustment of each apparatus can be omitted because pieces of information specific to the 3D display control terminal 101 (3D display device 103) and 3D image printing apparatus 104 and 3D edit information for a 3D image are communicated between the 3D display control terminal 101 and the 3D image printing apparatus 104.

The first embodiment assumes that the 3D display control terminal 101, 3D image printing apparatus 104, and 3D image managing server 105 are apparatuses independent of each other. However, the 3D display control terminal 101 and 3D image managing server 105 may be combined into one 3D image editing apparatus (e.g., general-purpose computer) without the mediacy of the network 106.

In the first embodiment, the 3D display control terminal 101 adjusts a 3D scene, and then requests the 3D image managing server 105 to perform 3D printing by the 3D image printing apparatus 104. However, this configuration is not always necessary, and the process flow can also be changed as follows.

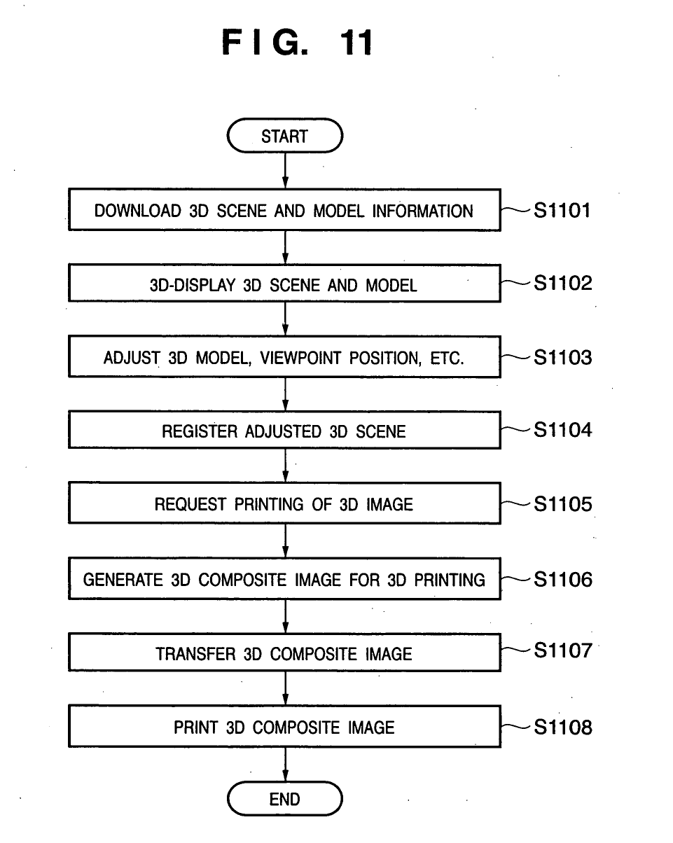

FIG. 11 is a flowchart showing the overall flow of the process according to a modification. This flowchart is almost the same as the flowchart shown in FIG. 3 except that step S1104 is added. Only steps S1104 and S1105 will be explained, and a description of the remaining steps will be omitted.

In step S1104, a 3D scene (3D image information) which is edited while a 3D image is observed on the 3D display control terminal 101 (3D display device 103) is registered in the 3D image managing server 105. Upon registration, a registration ID or the like is issued from the 3D image managing server 105 to the 3D display control terminal 101. At this time, only the edited 3D scene is registered, and the 3D image managing server 105 need not be instructed to print by the 3D image printing apparatus 104.

In step S1005, a 3D image printing apparatus 104 which is to print, and the edited 3D scene which has been registered are designated simultaneously. Upon reception of a request from the 3D display control terminal 101, the 3D image managing server 105 starts a process of generating a 3D image suitable for the 3D image printing apparatus 104. This process is the same as step S305 in the flowchart of FIG. 3.

According to this process flow, various 3D image printing apparatuses 104 connected to the network 106 can repetitively print the 3D image of a 3D scene which has been registered (saved). In addition, a proper 3D image printing apparatus can be selected, further improving user friendliness. Instead of or together with an edited 3D scene, a generated 3D print image may also be registered.

### Second Embodiment

In the system according to the first embodiment, a 3D scene or 3D model which is saved in the 3D image managing server 105 is used and edited in accordance with user tastes, and a 3D print image corresponding to the edited 3D scene is acquired. With this configuration, the administrator or hosting company of the 3D image managing server 105 can charge the user for the use of a 3D print image which has been created on the basis of an original 3D scene or 3D model.

In this case, the 3D image managing server 105 requests the user of the system to register him. When the 3D image managing server 105 receives a request to create an edited 3D scene and 3D print image or a request to print an image, it charges the registered user. More specifically, the charging step is added to the flowchart of FIG. 3 or 11.

The 3D image managing server 105 may cause the 3D image printing apparatus 104 which has received 3D print image data to actually print after a regular fee is paid.

### Third Embodiment

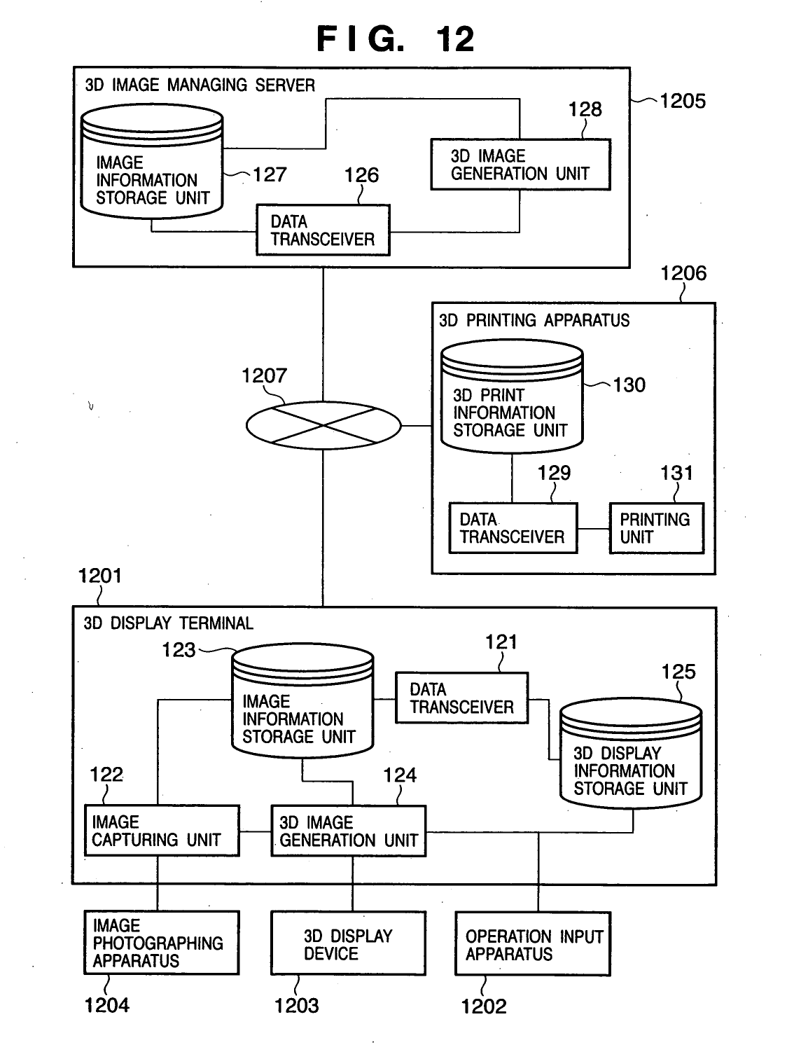

FIG. 12 shows the configuration of a 3D image printing system according to the third embodiment of the present invention. In the 3D image printing system according to the third embodiment, a 3D display control terminal 1201 which displays a 3D image on a 3D display device 1203, a 3D image managing server 1205 which manages 3D image information, and a 3D image printing apparatus 1206 are connected to each other via a network 1207. The 3D display control terminal 1201 according to the third embodiment has a function of capturing an image photographed by an image photographing apparatus 1204.

The 3D display control terminal 1201 is formed from, e.g., a general-purpose computer, and connected to the 3D display device 1203 which presents a 3D vision via a specific optical system, an operation input apparatus 1202 used when the user interactively operates the 3D display control terminal 1201, and the image photographing apparatus 1204 which photographs an image.

The 3D display control terminal 1201 is a 3D image editing apparatus which can interactively change a depth to be added to a photographed image and perform editing such as 3D adjustment and processing while presenting a 3D vision on the 3D display device 1203.

The 3D display control terminal 1201 comprises a data transceiver 121, image information temporary storage unit 123, 3D display information storage unit 125, 3D display image generation unit 124, and image capturing unit 122.

The data transceiver 121 exchanges data with the 3D image managing server 1205 via the network 1207. The image information temporary storage unit 123 stores image information such as a photographed image. The 3D display information storage unit 125 stores 3D display information as device-specific parameters associated with 3D display of the 3D display device 1203. The 3D display image generation unit 124 generates a 3D image to be displayed on the 3D display device 1203.

The image capturing unit 122 is connected to the image photographing apparatus 1204 by a known connection scheme (e.g., USB) or dedicated connection scheme, and captures data of a photographed image. The image photographing apparatus 1204 may be incorporated in the 3D image display terminal 1201.

The image information storage unit 123 comprehensively stores image data captured by the image capturing unit 122, photographing information (e.g., focal length in photographing) which is acquired from the image photographing apparatus 1204 upon capturing, and information (3D edit information) on 3D editing operation (e.g., adjustment and processing) that is input by the user via the operation input apparatus 1202.

The 3D image generation unit 124 generates a 3D image corresponding to the 3D display device 1203. The data transceiver 121 exchanges 3D image information (to be described later) with the 3D image managing server 1205 via the network 1207.

The operation input apparatus 1202, 3D display device 1203, 3D image printing apparatus 1206, and network 1207 are the same as those in the first embodiment, and a description thereof will be omitted.

The 3D image managing server 1205 is formed from, e.g., a general-purpose computer, and comprises a data transceiver 126, image information storage unit 127, and 3D image generation unit 128.

The data transceiver 126 communicates image data and the like with the 3D display control terminal 1201 and 3D image printing apparatus 1206 via the network 1207.

The image information storage unit 127 stores image information acquired by the 3D display control terminal 1201, 3D edit information obtained by the user via the operation input apparatus 1202, device-specific information as parameters associated with 3D display of the 3D display control terminal 1201 (3D display device 1203), and apparatus-specific information as parameters associated with 3D printing of a desired 3D image printing apparatus 1206.

The 3D image generation unit 128 generates a 3D image by converting 3D image information transferred from the 3D display control terminal 1201 into a form suitable for the 3D image printing apparatus 1206, and transfers the 3D image to the 3D image printing apparatus 1206.

The 3D image printing apparatus 1206 comprises a data transceiver 129, 3D print information storage unit 130, and printing unit 131. The data transceiver 129 exchanges various data with the 3D image managing server 1205 via the network 1207.

The 3D print information storage unit 130 stores apparatus-specific information (3D print information) on 3D printing of the 3D image printing apparatus 1206. The printing unit 131 prints, on a predetermined medium, a 3D print image transferred from the 3D image managing server 1205. The user sees the printed image via a predetermined optical member, and can observe the 3D image.

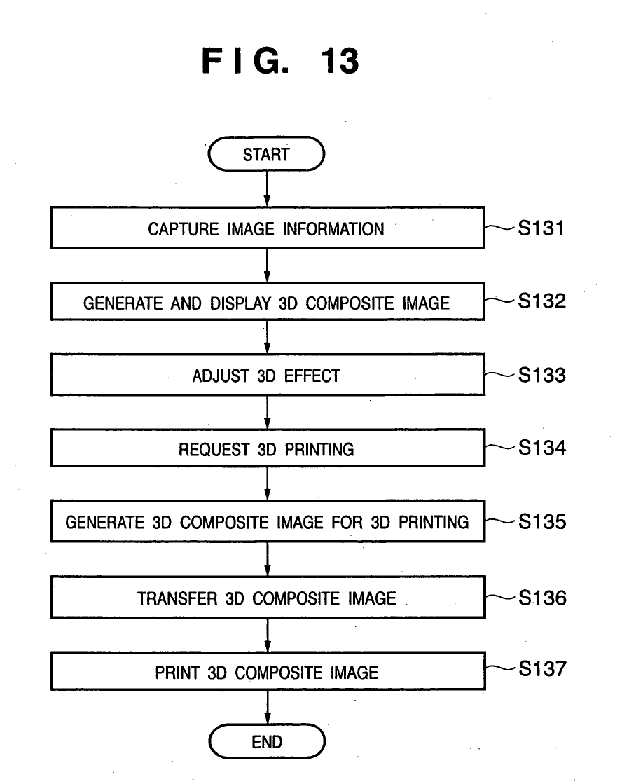

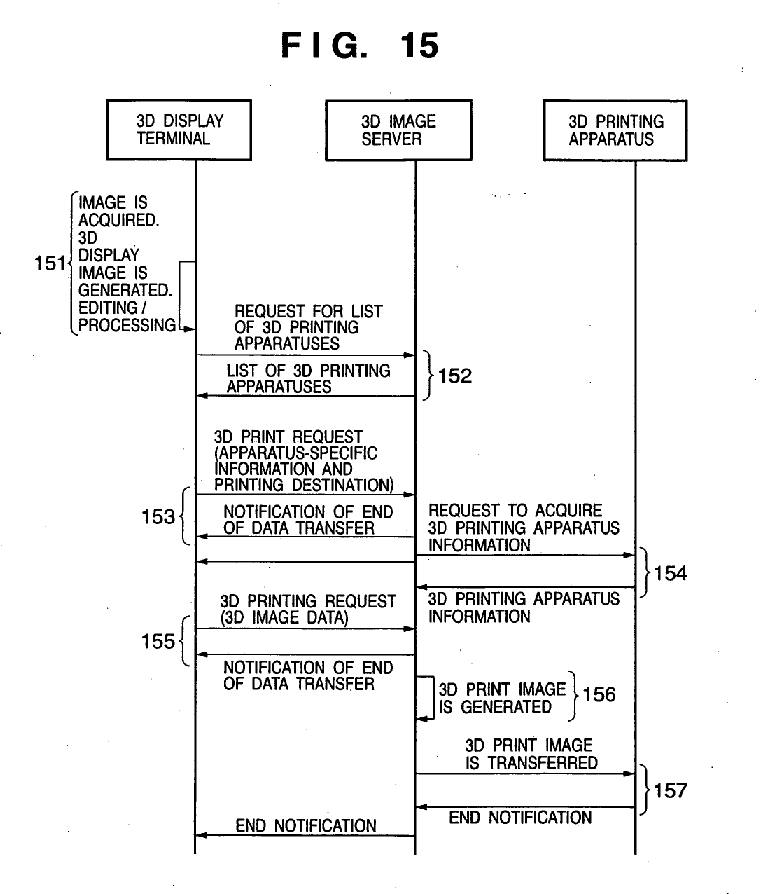

The overall process flow in the 3D image printing system according to the third embodiment will be explained in detail with reference to the flowchart shown in FIG. 13 and the sequence chart shown in FIG. 15.

In step S131, the 3D display control terminal 1201 captures from the image capturing unit 122 an image photographed by the image photographing apparatus 1204 which is connected to the terminal 1201 (151 in FIG. 15). The image photographing apparatus 1204 may be a general digital camera, or a 3D picture photographing digital camera which is constructed by mounting a stereoscopic adaptor on an image processing apparatus disclosed by the present applicant in Japanese Patent Laid-Open No. 2001-346226. Images photographed by a plurality of digital cameras may be simply captured. For descriptive convenience, the use of a general digital camera will be described.

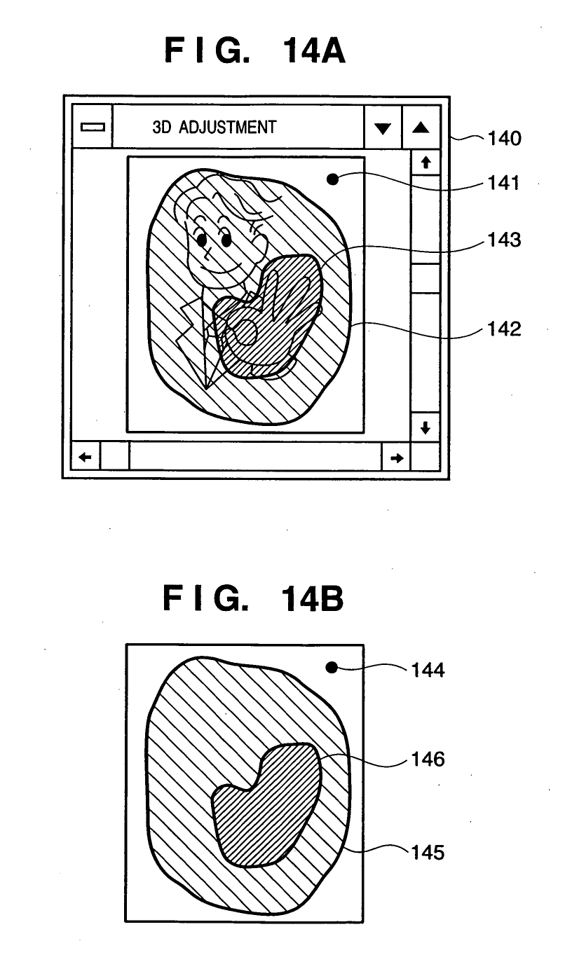

In step S132, the 3D display control terminal 1201 generates a 3D image to be displayed on the 3D display device 1203 on the basis of the captured image. A 3D image generation method will be schematically explained with reference to FIGS. 14A and 14B.

In FIG. 14A, an image 141 photographed by the image photographing apparatus 1204 is displayed in a window 140. The image 141 is a 2D image. In this state, the user uses the operation input apparatus 1202 to designate a principal object area 142 which does not pop up or sink in 3D vision and contains a principle object, a pop-up area 143 which is displayed to pop up in 3D vision, and the sinking area 141 which is displayed to sink in 3D vision. Based on information of the designated (3D edited) area, a depth map (depth information) as shown in FIG. 14B can be generated.

Image data of new viewpoint positions can be generated by forward mapping from the depth map and acquired image. Assume that a photographed image is an original image. Letting (x,y) be the pixel position of the original image, d be the parallax between the new viewpoint image and the original image, r be the ratio representing a viewpoint position, sh be the perspective parallax adjustment amount, h be the size of the original image, and H be the size of the new viewpoint image, a pixel position (xN,yN) in a new viewpoint image in which each pixel of the original image is mapped is given by
xN=H/h×(x+r×(d−sh))
yN=y (1)

The parallax d in equation (1) is determined from the maximum/minimum parallax amount which is unique information on 3D display of the 3D display device 1203.

A pixel at a pixel position (x,y) in the original image is copied to the position (xN,yN) in the new viewpoint image. This process is repeated for all the pixels of the original image, and a padding (interpolation) process is done for a pixel at which no pixel is assigned from the original image among pixels of the new viewpoint image. The created image data at a plurality of viewpoints are composited into a 3D image in a form corresponding to the 3D display form of the 3D display device 1203, and the 3D image is displayed on the 3D display device 1203. Accordingly, the 3D image can be obtained.

In step S133, the user interactively adjusts the 3D effect via the operation input apparatus 1202 while observing the 3D image displayed on the 3D display device 1203. Adjustment (3D editing) of the 3D effect is performed by correcting the pop-up/sinking area designated by the user in step S132 or adjusting the parallax amount set in generating a new viewpoint image. The above-mentioned depth map, 3D effect adjustment parameters, and the like are 3D image information in the third embodiment.

In step S134, the 3D display control terminal 1201 issues to the 3D image managing server 1205 a request to print the edited 3D image information by a desired 3D image printing apparatus 1206 (153 to 155 in FIG. 15). At this time, information to be transmitted to the 3D image managing server 105 contains information on an image photographed by the image photographing apparatus 1204, edited 3D image information (parallax map and 3D effect adjustment parameters designated by the user) used to generate a 3D image, 3D display information on 3D display of the 3D display control terminal 1201 (3D display device 1203), and 3D print information on 3D printing of the 3D image managing server 1205.

The 3D print information on 3D printing of the 3D image managing server 1205 may be only information representing the type of apparatus or each information on apparatus-specific 3D display.

In step S135, a 3D print image which can reproduce the same 3D effect as that of 3D vision on the 3D display device 1203 is generated by the 3D image managing server 1205 on the basis of the photographed image transferred from the 3D display control terminal 1201, edited 3D image information, 3D display information, and 3D print information (156 in FIG. 15). As a detailed 3D image generation method, forward mapping as a method of generating a 3D image for display on the 3D display device 1203 in step S132 can be directly applied. At this time, an image at a new viewpoint is so generated as to have a parallax in consideration of a parallax range suited to the 3D image managing server 1205, a parallax range suited to the 3D display device 1203, and a 3D effect parameter set by the user. That is, the parallax adjustment amount sh in equation (1) may be changed. Alternatively, a parallax adjustment amount transform function f(α) may be defined for the 3D display control terminal 1201 and 3D image printing apparatus 1206 to change the pixel position (xN,yN) into
xN=H/h×(x+r×f(d−sh))
yN=y (2)
Generated images at a plurality of viewpoint positions are composited in accordance with the 3D display scheme of the 3D image printing apparatus 1206, generating a 3D print image.

In step S136, the 3D print image generated in step S135 is transferred to the 3D image managing server 1205.

In step S137, the 3D image printing apparatus 1206 receives and prints the transferred 3D print image. The user stereoscopically observes the printed image via a predetermined optical system. The 3D effect obtained at this time is the same as that obtained upon observation on the 3D display device 1203.

As described above, according to the third embodiment, an image photographed by the image photographing apparatus 1204 which is connected to or incorporated in the 3D display control terminal 1201 undergoes editing such as processing and adjustment so that a 3D vision can be presented on the 3D display control terminal 1201. The 3D image managing server 1205 uses the edited 3D image information to create a 3D print image corresponding to the 3D image printing apparatus 1206. The 3D image printing apparatus 1206 performs 3D printing to obtain a 3D print image having the same 3D effect as that edited by the 3D display control terminal 1201. As a result, user friendliness of a 3D print image is improved.

The third embodiment assumes that the 3D display control terminal 1201, 3D image printing apparatus 1206, and 3D image managing server 1205 are apparatuses independent of each other. However, the 3D display control terminal 1201 and 3D image managing server 1205 may be combined into one 3D image editing apparatus (e.g., general-purpose computer) without the mediacy of the network 1207.

Also in the third embodiment, similar to the first embodiment, the 3D image managing server 1205 may register (save) edited 3D image information or a generated 3D print image, and repetitively generate and print the 3D print image in response to subsequent requests from the 3D display control terminal 1201.

The third embodiment can also introduce a charging system as described in the second embodiment.

### Fourth Embodiment

The fourth embodiment is a modification to the third embodiment. The calculation amount becomes large when a 3D image is generated on the basis of an actually photographed image. When the calculation ability of a 3D display control terminal 1201 is poor, user friendliness also becomes poor. To prevent this, a 3D image managing server 1205 executes (asks) the new viewpoint image generation process in the generation process for a 3D image to be displayed on the 3D display device in step S132 of the flowchart in FIG. 13. In this case, a photographed image, parallax map, and 3D display information are transmitted to the 3D image managing server 1205.

In the fourth embodiment, a photographed image and the like are temporarily transferred to the 3D image managing server 1205. To 3D-print by a 3D image printing apparatus 1206, only the adjustment result of the 3D effect or the like which is changed by the 3D display control terminal 1201, and a registration ID in the 3D image managing server 1205 are transferred.

### Fifth Embodiment

In the above embodiments, whether an image (medium) printed by the 3D image printing apparatus is a general 2D image or 3D print image may not be definitely determined by only seeing the printed image. To prevent this, the 3D image managing server may transmit to the 3D image printing apparatus a request to print a mark (e.g., “3D”) representing a 3D print image on a medium on which at least the 3D print image is printed.

The present invention is not limited to the configurations of the above-described embodiments. The present invention may be applied to a system including a plurality of devices or an apparatus formed by a single device.

The present invention is also implemented when a storage medium which stores software program codes for implementing the functions of the above-described embodiments is supplied to a system or apparatus, and the computer (or the CPU or MPU) of the system or apparatus reads out and executes the program codes stored in the storage medium. In this case, the program codes read out from the storage medium implement the functions of the above-described embodiments, and the storage medium which stores the program codes constitutes the present invention.

The storage medium for supplying the program codes includes a floppy® disk, hard disk, optical disk, magnetooptical disk, CD-ROM, CD-R/RW, magnetic tape, nonvolatile memory card, and ROM.

The functions of the above-described embodiments are implemented when the computer executes the readout program codes. Also, the present invention includes a case wherein an OS or the like running on the computer performs some or all of actual processes on the basis of the instructions of the program codes and thereby implements the functions of the above-described embodiments.

Furthermore, the present invention includes a case wherein, after the program codes read out from the storage medium are written in the memory of a function expansion board inserted into the computer or the memory of a function expansion unit connected to the computer, the CPU of the function expansion board or function expansion unit performs some or all of actual processes on the basis of the instructions of the program codes and thereby implements the functions of the above-described embodiments.

According to the embodiments, a 3D print image corresponding to a printing apparatus can be easily generated and printed on the basis of 3D image information and 3D print information which are obtained by 3D editing operation in a 3D image editing apparatus. In 3D editing while presenting a 3D vision on a 3D display device, a 3D print image is generated and printed on the basis of 3D image information, 3D print information, and 3D display information. In this case, the same 3D image as that observed on the 3D display device can be observed using the 3D print image.

From the above embodiments, the following inventions or aspects can be derived.

(1) In a 3D printing system having a 3D image managing server which manages 3D image information, a 3D display control terminal which acquires the 3D image information from the 3D image managing server via a communication network, performs 3D display, and interactively edits the 3D image information, and a 3D image printing apparatus which prints the 3D print image on the basis of the 3D image information edited by the 3D display control terminal,

the 3D display control terminal comprises a 3D display information storage means for storing 3D display information on 3D display, a 3D image information managing means for managing 3D image information used for 3D display, and a 3D image information transmission means for transmitting the 3D image information to the 3D image managing server,

the 3D image managing server comprises a 3D image information reception means for receiving the 3D image information transmitted from the 3D display control terminal, a 3D print information acquisition means for acquiring 3D print information on 3D printing of the 3D image printing apparatus, and a 3D print image generation means for generating a 3D print image corresponding to the 3D image printing apparatus from the 3D image information by using the 3D print information, and

the 3D image printing apparatus has a 3D print information storage means for storing the 3D print information.

(2) In a 3D image printing system having a 3D image managing server which manages 3D image information, a 3D display control terminal which acquires the 3D image information from the 3D image managing server via a communication network, performs 3D display, and interactively edits the 3D image information, and a 3D image printing apparatus which prints the 3D print image on the basis of the 3D image information edited by the 3D display control terminal,

the 3D display control terminal comprises a 3D display information storage means for storing 3D display information on 3D display, a 3D image information managing means for managing 3D image information used for 3D display, and a 3D image information transmission means for transmitting the 3D image information to the 3D image managing server,

the 3D image managing server comprises a 3D image information reception means for receiving the 3D image information transmitted from the 3D display control terminal, a 3D display image generation means for generating a 3D image corresponding to the 3D display control terminal from the 3D display information, a 3D print information acquisition means for acquiring 3D print information on 3D printing of the 3D image printing apparatus, and a 3D print image generation means for generating a 3D print image corresponding to the 3D image printing apparatus from the 3D image information by using the 3D print information, and

the 3D image printing apparatus has a 3D print information storage means for storing the 3D print information.

(3) In the 3D image printing system described in (1) or (2), the 3D display information contains at least one of the type of apparatus which performs 3D display, the 3D display scheme, the pixel arrangement style, the screen size, the screen resolution, the optimal observation distance, and the maximum/minimum parallax amount.

(4) In the 3D image printing system described in (1) or (2), the 3D image information which is transferred from the 3D display control terminal to the 3D image managing server contains at least one of information on a difference from 3D image information acquired from the 3D image managing server, the center of virtual viewpoints, the line of sight, and a point of interest.

(5) In the 3D image printing system described in (1) or (2), the 3D print information contains at least one of the type of printing apparatus, the 3D display scheme, the pixel arrangement style, the print medium size, the print resolution, the optimal observation distance, and the maximum/minimum parallax amount.

(6) In the 3D image printing system described in (1) or (2), the 3D image information which is transmitted from the 3D image information transmission means to the 3D image managing server does not contain any geometric information acquired from the 3D image managing server.

(7) In the 3D image printing system described in (1) or (2), the 3D image information transmission means selects only data of a changeable part from the 3D image information, and transmits only difference information to the 3D image managing server.

(8) In the 3D image printing system described in (1) or (2), the 3D image managing server generates the 3D print image by replacing the 3D print image with high-resolution geometric information, and rendering the 3D image.

(9) In the 3D image printing system described in (1) or (2), the 3D print image is losslessly compressed in transferring the 3D print image from the 3D image managing server to the 3D image printing apparatus.

(10) In a 3D image printing system having a 3D display control terminal which acquires image data, creates a 3D image for 3D display from the acquired image data, and performs 3D display, a 3D image managing server which receives the 3D image and generates a 3D print image for 3D printing, and a 3D image printing apparatus which prints the 3D print image generated by the 3D image managing server,

the 3D display control terminal comprises a 3D display information storage means for storing 3D display information on 3D display, a 3D image information managing means for managing 3D image information containing acquired image data, 3D display accessory information for 3D-displaying the image data, and a 3D effect adjustment parameter for adjusting the 3D effect, and a transmission means for transmitting the 3D display information and 3D image information to the 3D image managing server,

the 3D image managing server comprises a 3D image reception means for receiving the 3D image information transmitted from the 3D display control terminal, a 3D print information acquisition means for acquiring 3D print information on 3D printing of the 3D image printing apparatus, and a 3D print image generation means for generating a 3D print image corresponding to the 3D image printing apparatus from the 3D image information by using the 3D print information, and

the 3D image printing apparatus has a 3D print information storage means for storing the 3D print information.

(11) In a 3D image printing system having a 3D display control terminal which acquires image data, creates a 3D image for 3D display from the acquired image data, and performs 3D display, a 3D image managing server which receives the 3D image and generates a 3D print image for 3D printing, and a 3D image printing apparatus which prints the 3D print image generated by the 3D image managing server,

the 3D display control terminal comprises a 3D display information storage means for storing 3D display information on 3D display, a 3D image information managing means for managing 3D image information containing acquired image data, 3D display accessory information for 3D-displaying the image data, and a 3D effect adjustment parameter for adjusting the 3D effect, and a transmission means for transmitting the 3D display information and 3D image information to the 3D image managing server,

the 3D image managing server comprises a 3D image reception means for receiving the 3D image information transmitted from the 3D display control terminal, a 3D image generation means for generating a 3D image corresponding to the 3D display control terminal from the 3D image information, a 3D print information acquisition means for acquiring 3D print information on 3D printing of the 3D image printing apparatus, and a 3D print image generation means for generating a 3D print image corresponding to the 3D image printing apparatus from the 3D image information by using the 3D print information, and

the 3D image printing apparatus has a 3D print information storage means for storing the 3D print information.

(12) In the 3D image printing system described in (10) or (11), the 3D display information contains at least one of the type of apparatus which performs 3D display, the 3D display scheme, the pixel arrangement style, the screen size, the screen resolution, the optimal observation distance, and the maximum/minimum parallax amount.

(13) In the 3D image printing system described in (10) or (11), the 3D print information contains at least one of the type of printing apparatus, the 3D display scheme, the pixel arrangement style, the print medium size, the print resolution, the optimal observation distance, and the maximum/minimum parallax amount.

(14) In the 3D image printing system described in (10) or (11), the 3D display accessory information is depth information corresponding to each pixel of acquired image data.

(15) In the 3D image printing system described in (10) or (11), the 3D image information contains a 3D composite image which is composited so that it can be displayed on the 3D image display terminal, and pixel arrangement information of the 3D composite image.

(16) A 3D image editing apparatus comprises a 3D display information storage means for storing 3D display information on 3D display of a 3D display device, a 3D print information storage means for storing 3D print information on 3D printing of the 3D image printing apparatus, a 3D display image generation means for generating a 3D image to be displayed on the 3D display device, and a 3D print image generation means for generating a 3D print image from the edited 3D image by using the 3D display information and 3D print information while presenting a 3D vision on the 3D display device.

(17) A 3D image editing apparatus comprises a 3D display information storage means for storing 3D display information on 3D display of a 3D display device, a 3D print information storage means for storing 3D print information on 3D printing of the 3D image printing apparatus, a 3D image generation means for generating a 3D image corresponding to the 3D display device 103 from acquired image data, a 3D display adjustment means for adjusting the 3D effect and the like on the 3D display device for the 3D image generated by the 3D image generation means, and a 3D print image generation means for generating a 3D print image from the edited 3D image by using the 3D display information and 3D print information while presenting a 3D vision on the 3D display device.

(18) A method and computer program for performing 3D printing by the functions of the 3D image printing system and 3D image editing apparatus described in (1) to (17).

As many apparently widely different embodiments of the present invention can be made without departing from the spirit and scope thereof, it is to be understood that the invention is not limited to the specific embodiments thereof except as defined in the appended claims.

### CLAIM OF PRIORITY

This application claims priority from Japanese Patent Application No. 2004-294203 filed on Oct. 6, 2004, which is hereby incorporated by reference herein.

What is claimed is:

1. A 3D image printing system comprising:
a managing apparatus which saves first 3D image information;
an editing apparatus which edits the 3D image; and
a printing apparatus which prints the 3D image,
wherein said editing apparatus generates a second 3D image information with the first 3D image information, in accordance with 3D editing operation by said editing apparatus, and
said managing apparatus generates a 3D print image on the basis of the second 3D image information and 3D print information on 3D printing of said printing apparatus, and causes said printing apparatus to print the 3D print image.

2. The system according to claim 1, wherein said editing apparatus generates a 3D image by using the first 3D image information, and displays the 3D image on a 3D display device.

3. The system according to claim 1, wherein said managing apparatus generates the 3D print image on the basis of the second 3D image information, 3D display information on 3D display of the 3D display device, and the 3D print information.

4. The system according to claim 1, wherein said managing apparatus saves the second 3D image information or the 3D print image, and causes said printing apparatus to print the 3D print image in accordance with a subsequent request from said editing apparatus.

5. The system according to claim 1, further comprising a plurality of printing apparatuses having different pieces of 3D print information,
wherein said editing apparatus designates via said managing apparatus a printing apparatus which is to print the 3D print image among said plurality of printing apparatuses.

6. The system according to claim 1, wherein said managing apparatus, said editing apparatus, and said printing apparatus can communicate with each other via a communication network.

7. The system according to claim 1, wherein said managing apparatus charges a user for generation or printing of the 3D print image.

8. The system according to claim 1, wherein said managing apparatus causes said printing apparatus to print a mark on a medium on which the 3D print image is to be printed.

9. A 3D image printing system comprising:
a managing apparatus;
an editing apparatus which edits a 3D image; and
a printing apparatus which prints the 3D image,
wherein said editing apparatus generates 3D image information used to generate the 3D image, in accordance with 3D image editing operation using a photographed image acquired from a photographing apparatus, and
said managing apparatus receives the 3D image information from said editing apparatus, generates a 3D print image on the basis of the 3D image information and 3D print information on 3D printing of said printing apparatus, and causes said printing apparatus to print the 3D print image.

10. The system according to claim 9, wherein said editing apparatus generates a 3D image by using the 3D image information, and displays the 3D image on a 3D display device.

11. The system according to claim 10, wherein said managing apparatus generates the 3D print image on the basis of the 3D image information, 3D display information on 3D display of the 3D display device, and the 3D print information.

12. The system according to claim 9, wherein said managing apparatus generates, on the basis of the 3D image information, a viewpoint image used to generate the 3D image by said editing apparatus.

13. The system according to claim 9, wherein said managing apparatus saves the 3D image information or the 3D print image, and causes said printing apparatus to print the 3D print image in accordance with a subsequent request from said editing apparatus.

14. A 3D image editing apparatus which generates a 3D print image to be printed by a printing apparatus, comprising:
a storage unit which saves first 3D image information;
an editing unit which edits, in accordance with 3D image editing operation, the first 3D image information read out from said storage unit, and
an image generation unit which generates the 3D print image on the basis of second 3D image information edited by said editing unit and 3D print information on 3D printing of the printing apparatus.

15. The apparatus according to claim 14, wherein
the 3D image editing apparatus displays, on a 3D display device, the 3D image generated on the basis of the 3D image information, and
said image generation unit generates the 3D print image on the basis of the 3D image information, 3D display information on 3D display of the 3D display device, and the 3D print information.

16. A 3D image editing apparatus which generates a 3D print image to be printed by a printing apparatus, comprising:
an image acquisition unit which acquires a photographed image from a photographing apparatus;
an information generation unit which generates, in accordance with 3D image editing operation using the photographed image, 3D image information used to generate the 3D image; and
an image generation unit which generates the 3D print image on the basis of the 3D image information and 3D print information on 3D printing of the printing apparatus.

17. A 3D image printing method using a 3D image printing system having a managing apparatus which saves first 3D image information used to generate a 3D image, an editing apparatus which edits the 3D image, and a printing apparatus which prints the 3D image, comprising steps of:
causing the editing apparatus to edit the first 3D image information received from the managing apparatus in accordance with 3D image editing operation;
causing the managing apparatus to receive second 3D image information edited by the editing apparatus, and generate a 3D print image on the basis of the second 3D image information and 3D print information on 3D printing of the printing apparatus;
causing the printing apparatus to print the 3D print image.

18. A 3D image printing method using a 3D image printing system having a managing apparatus, an editing apparatus which edits a 3D image, and a printing apparatus which prints the 3D image, comprising:
an editing step, of the editing apparatus to generate 3D image information used to generate the 3D image, in accordance with 3D image editing operation using a photographed image acquired from a photographing apparatus;
a generating step, of the managing apparatus to receive the 3D image information from the editing apparatus, and generate a 3D print image on the basis of the 3D image information and 3D print information on 3D printing of the printing apparatus; and
a printing step, of the printing apparatus to print the 3D print image.
